(19) United States
(12) Patent Application Publication
(10) Pub. No.: US 2015/0306717 A1
(43) Pub. Date: Oct. 29, 2015

(54) ROTARY MODULE

(71) Applicant: Ludwig Ehrhardt GmbH, Laubach (DE)

(72) Inventors: Winfried EHRHARDT, Laubach (DE); Rudolf KOHLERT, Stockstadt am Main (DE); Klaus RICHTER, Laubach (DE)

(21) Appl. No.: 14/430,828

(22) PCT Filed: Sep. 4, 2013
(86) PCT No.: PCT/EP2013/002656

§ 371 Date: Jul. 2, 2015

(30) Foreign Application Priority Data
Sep. 28, 2012 (DE) 10 2012 019 250.9

(51) Int. Cl. B23Q 1/48; B23Q 1/00

(52) U.S. Cl. CPC B23Q 1/488; B23Q 1/0018

(57) ABSTRACT

The invention relates to a rotary module (3, 4) for rotatably positioning a component, in particular in a handling device (1) or a mounting device, including a base part (15) having a mounting option for mounting the rotary module (3, 4) and having a rotary part (16) with a mounting option for mounting the component on the rotary module (3, 4), wherein the rotary part (16) is rotatable relative to the base part (15). It is proposed that the rotary module (3, 4) can be optionally configured for a motorized drive (10, 11, 13, 14) or for a manual drive.

The invention relates to a rotary module for rotatably positioning a component, in particular in a handling device or a mounting device.

Such rotary modules are known per se from the prior art and comprise a base part having a mounting option for mounting the rotary module, wherein the mounting option may consist, for example, of a threaded connection. Moreover, the known rotary modules comprise a rotary part which is rotatable relative to the base part and also comprise a mounting option so as to be able, for example, to secure a workpiece or any other component rotatably to the rotary module. In addition, the known rotary modules often comprise an indexing device for locking the rotary part relative to the base part in specified discrete angular positions.

With regard to the operation of such rotary modules, various types of construction are known from the prior art which are driven either manually or by a motor via a worm gear. The known rotary modules are each designed for a specific type of drive (manual or motorized) and do not enable any reconfiguration with regard to said drive type. It is also not possible with the known rotary modules to convert the rotary module from a motorized drive to a manual drive or vice versa.

Therefore, the lack of flexibility with regard to the desired type of drive is a disadvantage of the known rotary modules.

In addition to the prior art, reference is also made to DE 41 24 228 A1, DE 60 2004 010 912 T2, DE 27 23 146 A1, DE 18 00 036 A, DE 20 2010 009 079 U1 and DE 102 34 321 B3. These printed documents, however, only disclose rotary modules that can be driven either by motor or manually.

Thus the object of the invention is to create an appropriately improved rotary module.

This object is achieved by a rotary module according to the invention in accordance with the main claim.

In conformity with the prior art, the rotary module according to the invention comprises a base part and a rotary part which is rotatable relative to said base part, the base part and the rotary part each having mounting options for joining the rotary module to a component (e.g. workpiece or another rotary module).

Compared to the known rotary modules, the rotary module according to the invention is distinguished in that the rotary module is optionally configurable for a motorized drive or for a manual drive.

If a motorized drive of the rotary module is desirable, then a worm gear, for example, may be used in the housing of the rotary module, wherein the worm gear, for example, can be driven by an electric motor. However, such a worm gear is generally self-locking and therefore blocks manual operation of the rotary module when the electric motor is stationary.

Thus, if manual operation of the rotary module is desirable, the worm gear is preferably removed from the housing of the rotary module, with the result that manual operation is possible.

Within the scope of the invention, a motorized drive of the rotary module may be effected, for example, electromotively, pneumatically or hydraulically. In a preferred embodiment of the invention, however, an electric motor is used which rotates relative to the rotary part by way of a worm gear.

It has already been mentioned briefly that a motorized drive of the rotary module may be effected by way of a worm gear which is driven by a rotary motor (e.g. electric motor), wherein the worm gear is self-locking such that said worm gear blocks a rotary motion of the rotary part relative to the base part when the rotary motor is stationary. With an appropriately loadable mechanical design of the worm gear, said worm gear can therefore assume the function of a locking device which locks the rotary part in a specific angular position relative to the base part. In this case, it is possible to dispense with an additional indexing device.

In a preferred embodiment of the invention, however, the rotary module comprises an indexing device known per se which enables the rotary part to be locked in a specific angular position relative to the base part, wherein the indexing device preferably predetermines specific discrete angular positions. For example, the indexing device may enable rotation of the rotary part relative to the base part in angular steps of one degree each.

It should be further mentioned that the rotary module preferably has a rotary bushing to guide lines between the base part and the rotary part.

In this case, it is advantageous if the rotary bushing is supported in an elastic bearing in the rotary module. Thus, due to the load torques, the bearing with the rotary part is subject to an elastic deformation which is also experienced by the rotary bushing supported on the rotary part. The rotary bushing should therefore be supported in the base part without force.

The rotary bushing preferably accommodates at least two, three or even at least four fluid lines, wherein these are, for example, hydraulic lines or pneumatic lines. For example, it is possible to guide three hydraulic lines and one pneumatic line through the rotary bushing such that both hydraulic lines and also pneumatic lines are available on the rotary part.

In a preferred embodiment of the invention, the rotary bushing accommodates both a forward line and also a return line for a fluid (e.g. hydraulic fluid), wherein the forward line conducts the fluid from the base part to the rotary part, while the return line conducts the fluid back from said rotary part to said base part. In this way, it is possible to implement a fluid circuit (e.g. hydraulic circuit) which extends through the rotary bushing and enables a circulation of material through the rotary bushing.

In addition, the rotary bushing preferably accommodates at least one electric cable. In general, however, the rotary bushing contains a plurality of electric cables. The electric cable in question may be, for example, a control cable for actuating valves or the like. Moreover, the electric cable may also be a sensor cable for feeding back sensor variables from the rotary part to the base part.

In the preferred embodiment of the invention, the electric cable runs centrally in the rotary bushing, while the fluid lines (e.g. hydraulic lines) run off-center in the rotary bushing.

It should also be mentioned that the rotary module according to the invention preferably comprises an roller bearing to rotatably support the rotary part and the base part. The rotary bushing for the lines preferably runs in this case through the inner ring of the roller bearing. It is therefore advantageous if the inner ring of the roller bearing has a correspondingly large internal diameter in order to be able to pass through as many lines as possible. The external diameter of the rotary part corresponds to the internal diameter of the ball cage and as a result is optimized for absorbing the load torques arising from the weight of the apparatus and mounting torques. The ball cage sits on the very outside of the rotary part. There is therefore sufficient space for the rotary bushings.

It should also be mentioned that the roller bearing is preferably a wire race bearing, in particular a wire race ball bearing, such roller bearings being known per se from the prior art and therefore not requiring more detailed description.

Additionally, in the preferred embodiment of the invention, couplings are attached to the rotary part and/or the base part for connecting the fluid lines and/or the electric cable. These couplings may be designed as plug-in couplings, for example, which enables easy connection and disconnection.

Moreover, the rotary module according to the invention may have an angle adapter which is secured to the base part or the rotary part and enables angled mounting. For example, two rotary modules according to the invention may be joined together by such an angle adapter, wherein the angle adapter is fixed to the rotary part of the one rotary module and to the base part of the other rotary module. The angle adapter preferably includes a right angle so that the rotary axes of the two rotary modules which are joined to one another are aligned at right angles to each other.

In a preferred embodiment of the invention, a valve unit is attached to the rotary part of the rotary module, wherein the valve unit can be optionally constructed as a separate unit or can be integrated in the rotary part. On the inlet side, this valve unit is connected to the fluid line coming from the base part and on the outlet side has a plurality of independently controllable fluid connections. The valve unit is actuated in this case by the electric cables coming from the base part. Such a valve unit offers the possibility for the number of independently controllable fluid connections of the valve unit to be greater than the number of fluid lines coming from the base part.

For example, merely one forward line and one return line for a hydraulic fluid may be passed through the rotary bushing in addition to a large number of electric cables for actuating valves of the valve unit. The individual valves of the valve unit are then connected to the fluid circuit of forward and return line and enable controlled fluid removal from the circuit. In this manner, a large number of independently controllable fluid connections can be provided in the rotary part although only two fluid lines have to be passed through the rotary bushing.

It should also be mentioned that further components can be attached to the rotary part, for example a valve, a relay, a clamping device or a sensor, such as a position sensor for determining the rotary position of the rotary part.

In addition to the rotary module described above, the invention also comprises a handling or mounting device with at least one such rotary module.

In a preferred embodiment of the invention, the handling device comprises a plurality of rotary modules which are arranged kinematically in series, wherein the rotary modules may have differently aligned rotary axes, for example a vertical rotary axis in the proximal rotary module and a horizontal rotary axis in the distal rotary module. In this case, the proximal rotary module and the distal rotary module are arranged kinematically in series, wherein the distal rotary module is arranged on the component side, while the proximal rotary module is arranged on the mounting side.

In addition, the handling device according to the invention may comprise a lifting column which enables a vertical lifting movement, wherein a drag chain may then be provided for introducing media.

In the preferred embodiment of the invention, a lifting column is provided which enables a vertical lifting movement, wherein the lifting column carries a first rotary module with a vertical rotary axis, while a second rotary module with a horizontal rotary axis is secured to the rotary part of said first rotary module.

Other advantageous developments of the invention are characterized in the dependent claims or will be described in greater detail below with reference to the figures together with the description of the preferred embodiments of the invention. The drawings show:

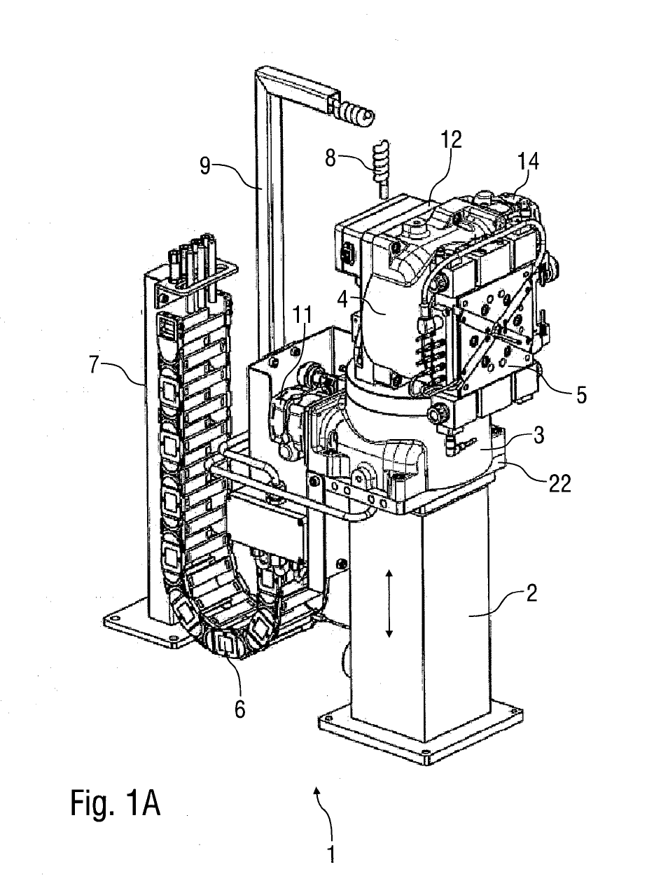

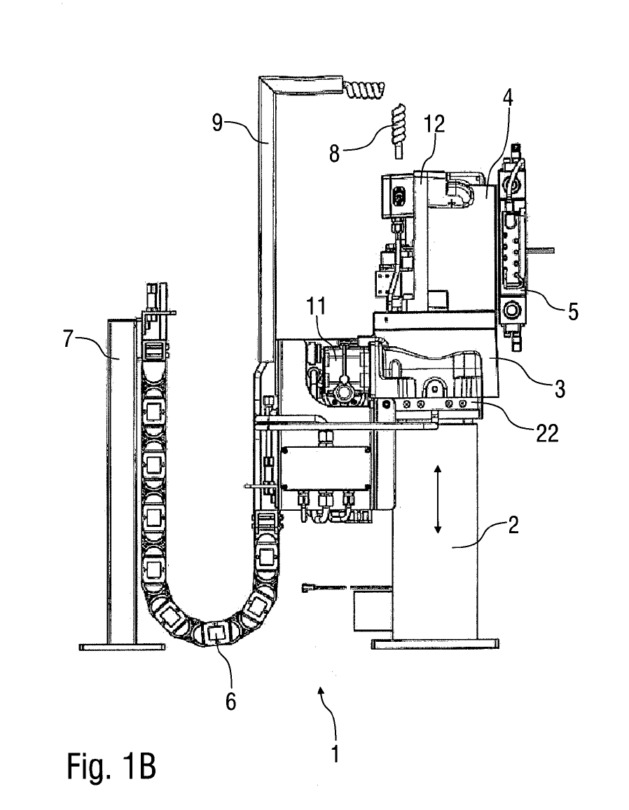

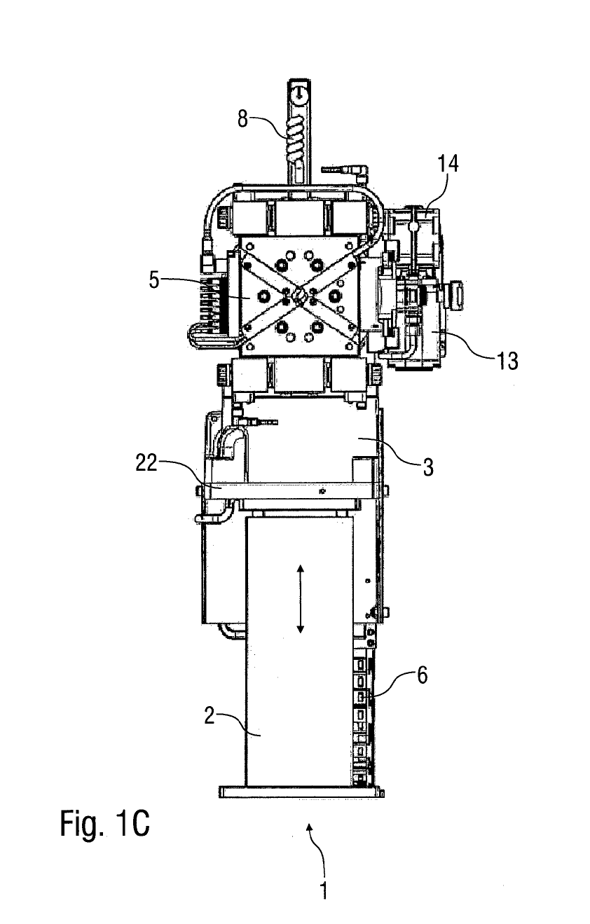

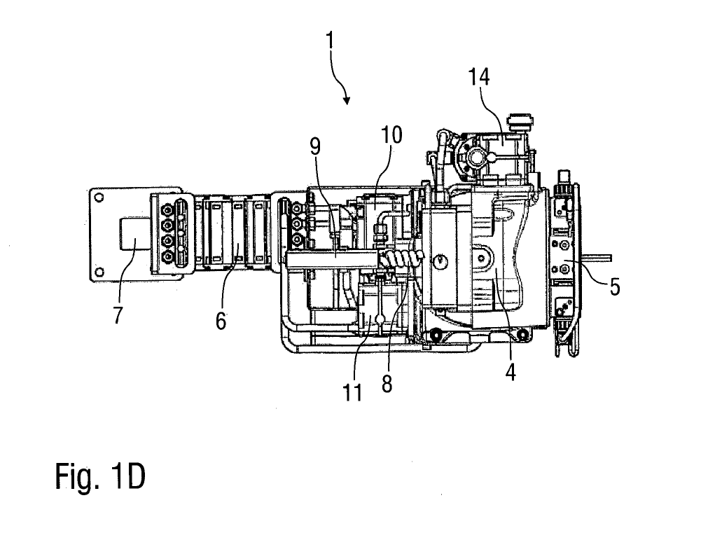

FIG. 1A a perspective view of a handling device according to the invention with a lifting column and two rotary modules,

FIG. 1B a lateral view of the handling device from FIG. 1B,

FIG. 1C a front view of the handling device from FIGS. 1A and 1B,

FIG. 1D a top view onto the handling device from FIGS. 1A to 1C,

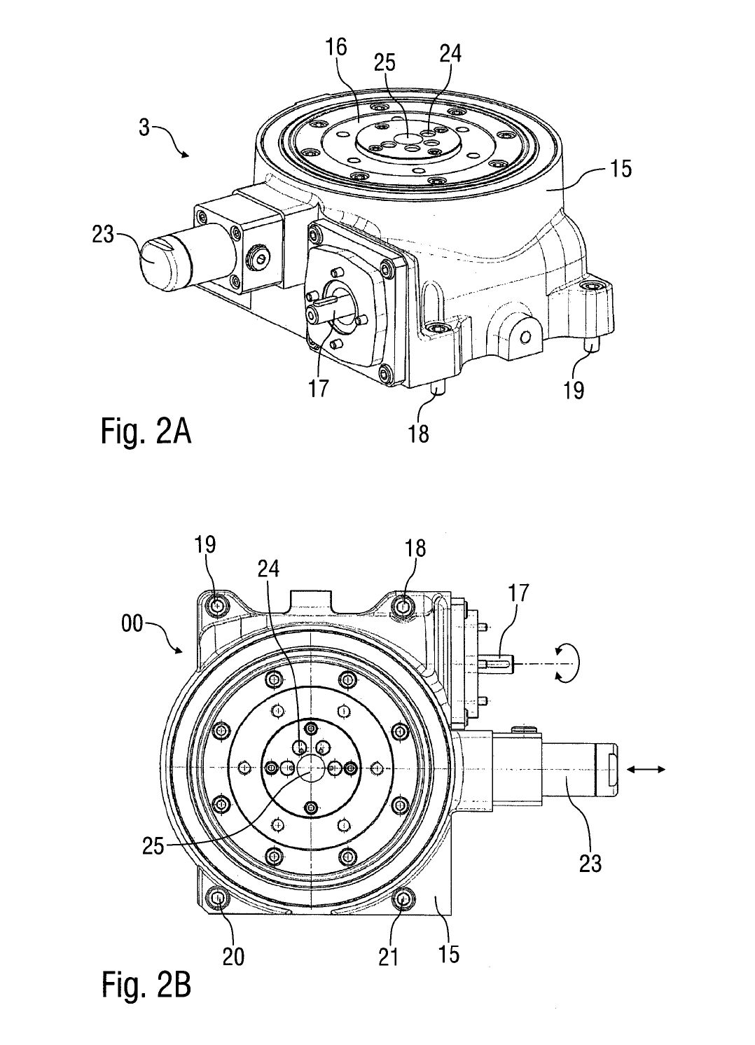

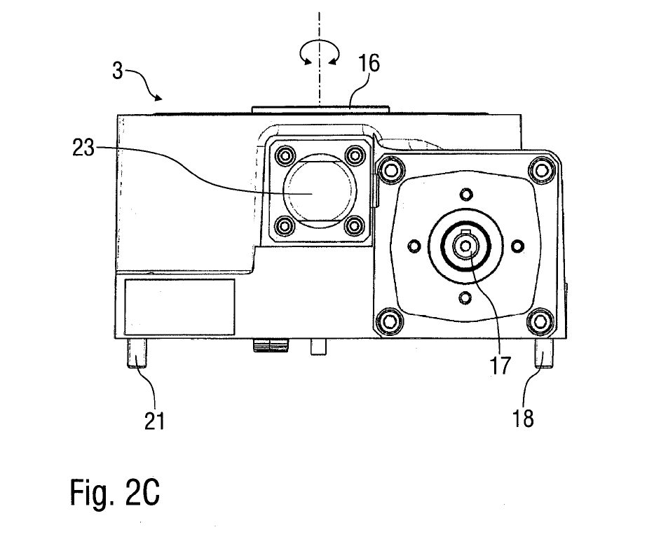

FIG. 2A a perspective view of a rotary module according to the invention, as is also included in the handling device according to FIGS. 1A to 1D,

FIG. 2B a top view onto the rotary module according to FIG. 2A,

FIG. 2C a lateral view of the rotary module from FIGS. 2A and 2B,

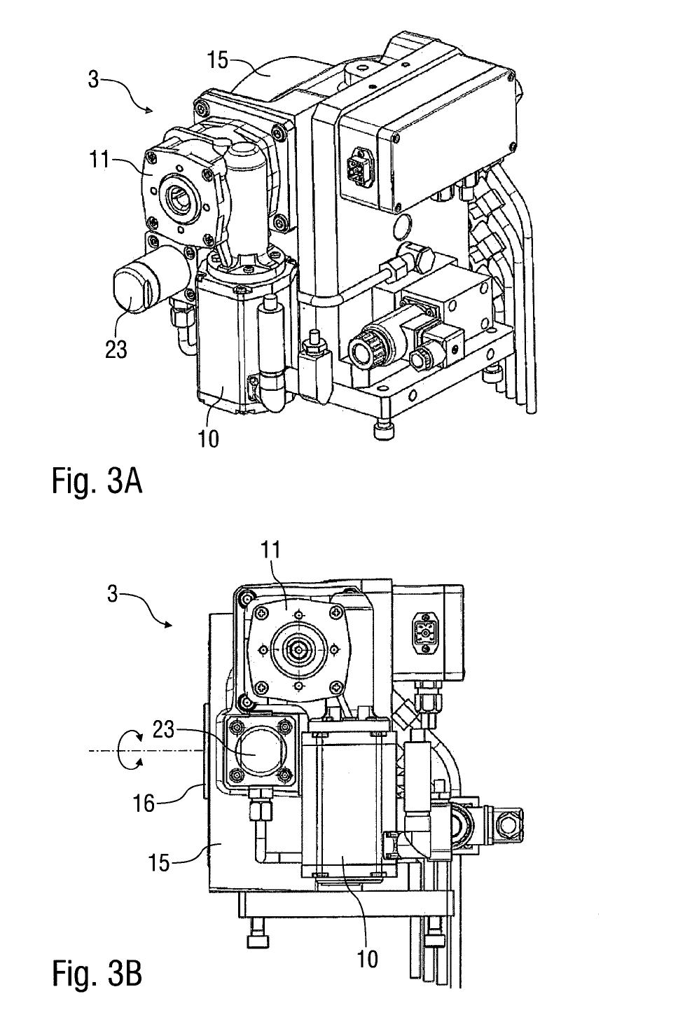

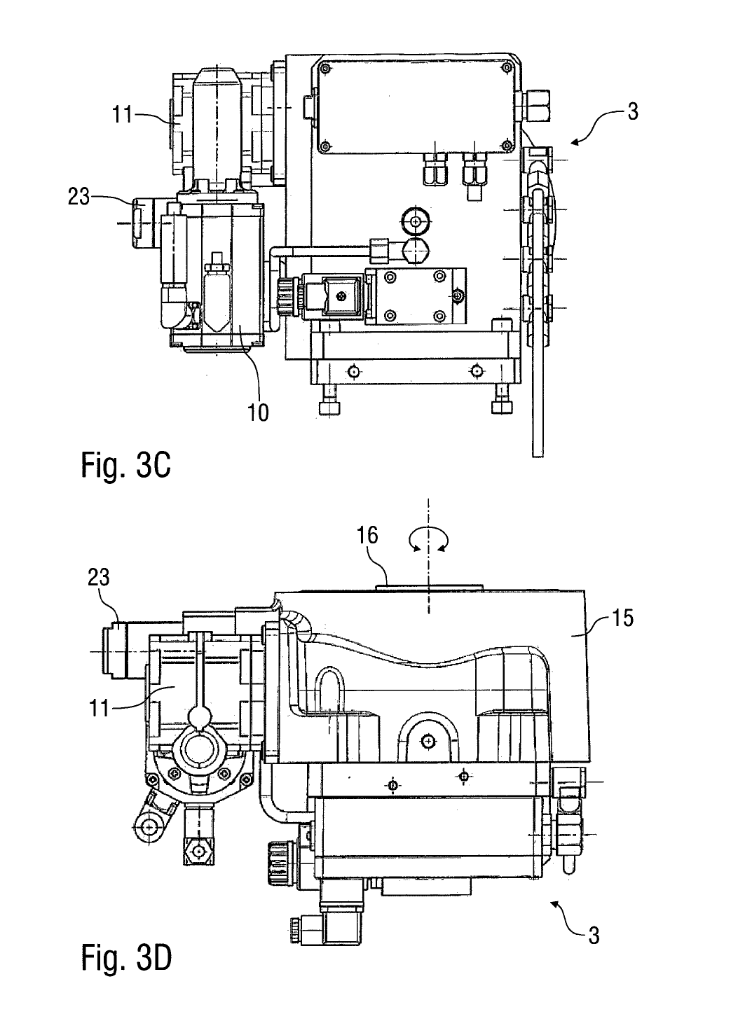

FIGS. 3A-3D various views of a further embodiment of a rotary module according to the invention,

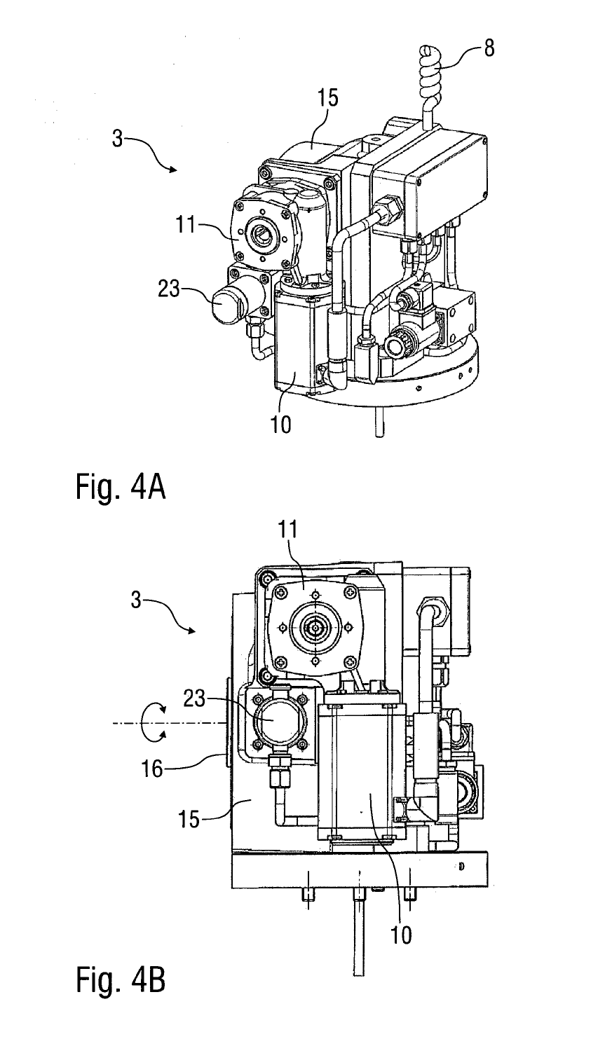

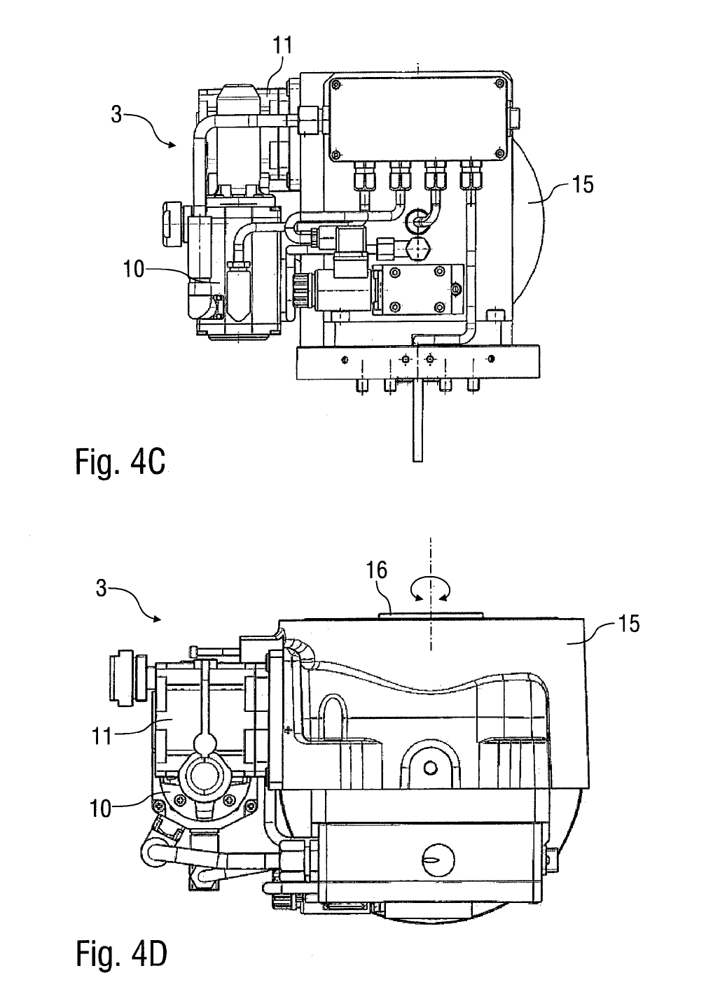

FIGS. 4A-4D various views of a different embodiment of a rotary module according to the invention,

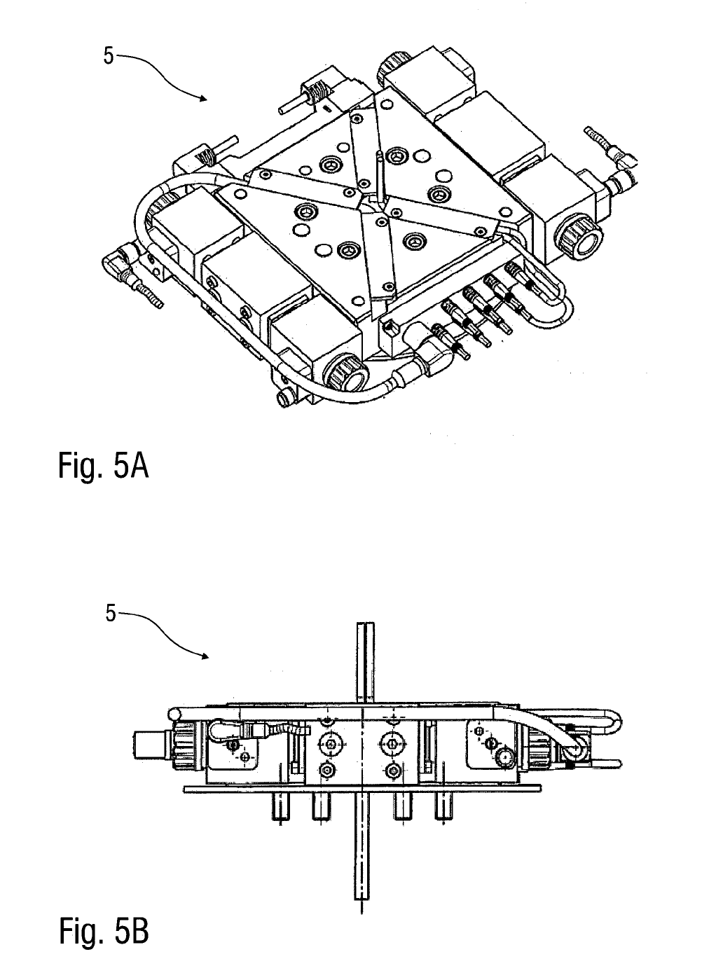

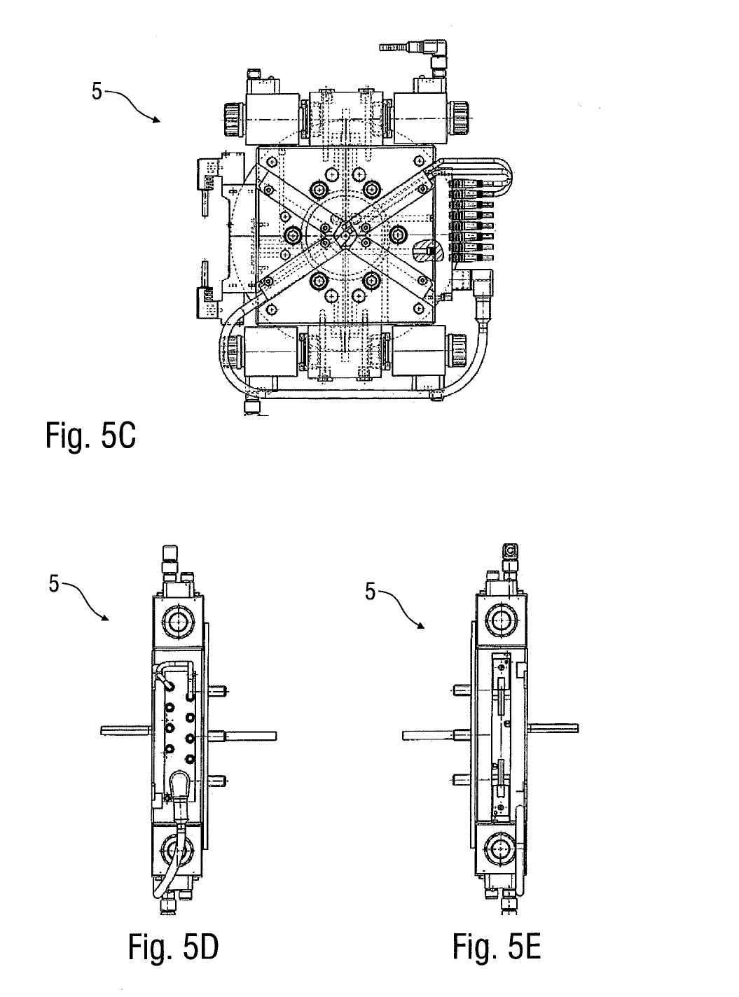

FIG. 5A a perspective view of a valve unit which is attached to the distal (component-side) rotary module in the handling device according to FIGS. 1A to 1D,

FIG. 5B a lateral view of the valve unit from FIG. 5A,

FIG. 5C a front view of the valve unit from FIGS. 5A and 5B,

FIG. 5D a lateral view of the valve unit from FIGS. 5A to 5C,

FIG. 5E a different lateral view of the valve unit from FIGS. 5A to 5D,

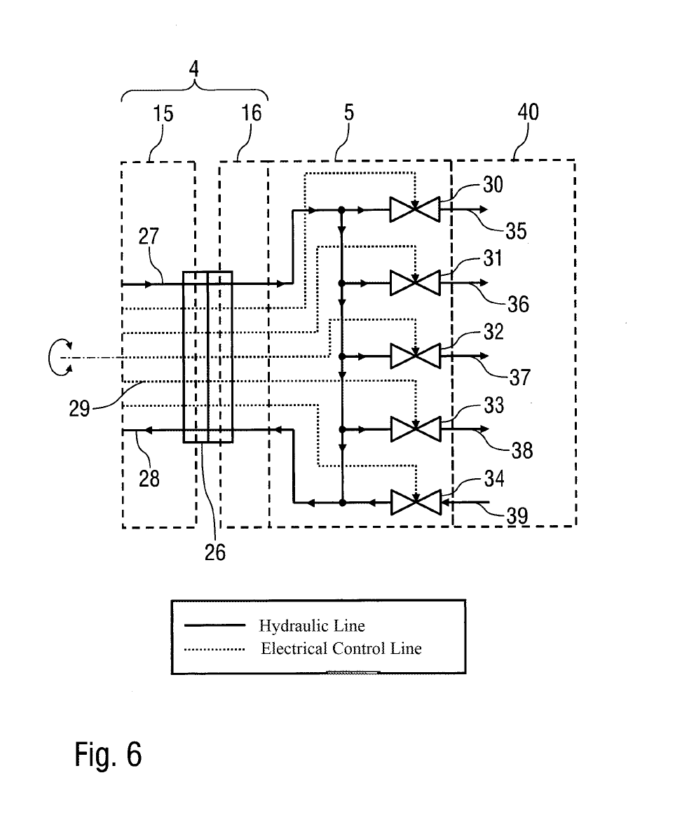

FIG. 6 a schematic representation of a handling device according to the invention with two rotary modules and a clamping device.

FIGS. 1A to 1D show various views of a handling device 1 according to the invention for handling components (e.g. workpieces), wherein the handling device 1, for example, can position a clamping device in space, which clamping device is not shown, however, in FIGS. 1A to 1D for the purpose of simplification.

The handling device 1 essentially comprises a lifting column 2, two rotary modules 3, 4 and a valve unit 5, wherein the rotary modules 3, 4 are each shown separately in FIGS. 2A to 2C, while the valve unit 5 is illustrated in FIGS. 5A to 5E.

The lifting column 2 enables a vertical movement of the rotary module 3 together with the rotary module 4 and the valve unit 5, wherein the vertical movement takes place in the direction indicated by the double-headed arrow in the drawing.

For introducing hydraulic lines, the lifting column 2 has a drag chain 6 which is suspended on a stand 7.

Furthermore, the lifting column 2 is connected via an electric cable 8 to a control unit, wherein the electric cable 8 is introduced via a stand 9.

The rotary module 3 is arranged on the upper side of the lifting column 2 and has a vertical rotary axis. The rotary module 3 thus enables rotation of the rotary module 4 with the valve unit 5 about a vertical rotary axis. In this case the rotary module 3 is driven by an electric motor 10 via a gear 11. The rotary module 3 is thus configured in this embodiment for a motorized drive. The rotary module 3 can also be configured, however, for a manual drive without needing to substantially alter said rotary module 3 structurally.

The rotary module 4 by comparison is mounted on the rotary module 3 by means of an angle adapter 12 such that the rotary axis of said rotary module 4 runs horizontally. The rotary module 4 thus enables rotation of the valve unit 5 about a horizontal rotary axis.

The rotary module 4 is driven by an electric motor 13 via a gear 14. The rotary module 4 is thus configured in this embodiment for a motorized drive. The rotary module 4 can also be configured, however, for a manual drive as will be described in detail later.

The valve unit 5 is used, for example, for actuating a clamping device which can be secured to the valve unit 5, wherein the precise construction and the operating principle of the valve unit 5 will be described in detail even later with reference to FIGS. 5A to 5E.

The construction and operating principle of the rotary module 3 will now be described below with reference to FIGS. 2A to 2C, wherein the rotary module 4 is constructed and functions in an identical manner.

The rotary module 3 has a base part 15 and a rotary part 16 which is rotatable relative to said base part 15, wherein said rotary part 16 is rotatably supported in said base part 15 by means of a wire race ball bearing.

Located in the base part 15 is a worm gear which can be driven via a drive shaft 17 and acts in a manner known per se on the rotary part 16 such that rotation of said drive shaft 17 leads to corresponding rotation of said rotary part 16 in said base part 15. In the embodiment according to FIGS. 1A to 1D, the drive shaft 17 is driven by the electric motors 10 or 13 via the gear 11 or 14 respectively.

In addition, the base part 15 of the rotary module 3 has threaded connections 18, 19, 20, 21 in order to be able to attach the base part 15 of the rotary module. In the handling device 1 according to FIGS. 1A to 1D, the threaded connections 18-21 are used for screwing the rotary module 3 firmly to an adapter 22. The adapter 22 is attached to the flange plate of the lifting column 2. Moreover, the rotary module 3 has an indexing device which enables it to lock the rotary part 16 in the base part 15 in specific discrete angular positions. The indexing device is operated by an axially displaceable tappet 23 which can be moved linearly in the direction of the double-headed arrow (cf. FIG. 2). To lock the rotary part 16 in the base part 15, the tappet 23 is pressed into the rotary module 3 by means of spring force. In contrast, to release the locking of the rotary part 16 in the base part 15, the tappet 23 is pulled out of the rotary module 3 hydraulically.

Furthermore, the rotary module 3 has four rotary bushings 24 for fluid lines in the rotary part 16, wherein three of the rotary bushings 24 are used to guide through hydraulic lines, while one of the rotary bushings 24 is used to guide through a pneumatic line (cf. FIGS. 2A, 2B).

In addition, the rotary module 3 also has a rotary bushing 25 (cf. FIGS. 2A, 2B) for electric cables as will be described later in detail.

On its upper face the rotary part 16 further has mounting options in order to be able to mount a component on the rotary part 16. In the handling device 1 according to FIGS. 1A to 1C, the angle adapter 12 is screwed firmly to the rotary part 16 of the rotary module 3.

FIGS. 3A to 3D and 4A to 4D show modifications of the rotary module 3 with the result that reference is made to the description above to avoid repetitions, wherein the same reference numerals are used for corresponding details. In this case, the rotary modules are essentially identical whereas the adapter is different.

FIGS. 5A to 5E show the valve unit 5 which is attached to the rotary module 4 and can be used, for example, to actuate a clamping device.

With reference to FIG. 6, the schematic representation shown there is described below, wherein reference is made to the description above to avoid repetition.

Thus the drawing shows, in a highly simplified form, the rotary module 4 with the base part 15 and the rotary part 16 as well as a rotary bushing 25.

On one hand, the rotary bushing 26 accommodates hydraulic lines which are represented by an unbroken line. Specifically, in this case, a forward line 27 and a return line 28, wherein the forward line 27 conducts hydraulic fluid from the base part 15 via the rotary part 16 to the valve unit 5. The return line 28, on the other hand, conducts the hydraulic fluid from the valve unit 5 via the rotary part 16 back to the base part 15.

In addition, the rotary bushing 26 also accommodates a plurality of electric control cables 29 which are represented by a dotted line.

In this case, the valve unit 5 contains a plurality of controllable valves 30-34 which provide a plurality of fluid connections 35-39 on the outlet side which are actuated independently of each other.

On the inlet side, the valves 30-34 are connected to a connecting line between the forward line 27 and the return line 28. Thus a hydraulic circuit flows through the forward line 27 and the return line 28, from which the valves 30-34 can take hydraulic fluid in order to actuate a clamping device 40 which is only illustrated schematically here. In this case, the valves 30-34 can be used optionally as feed valves or as return valves.

The invention is not restricted to the preferred embodiments described above. Rather, a large number of variants and modifications are possible which likewise make use of the inventive idea and therefore fall within the scope of protection. In addition, the invention also claims protection for the object and the features of the dependent claims regardless of the claims referred to and in particular independently of the feature of the rotating module's reconfigurability. For example, the invention also comprises a rotary module with a rotary bushing between the base part and the rotary part and preferably with a circulation of material through the rotary bushing but without reconfigurability for a manual or motorized drive.

### LIST OF REFERENCE NUMBERS

1 Handling device
2 Lifting column
3 Rotary module
4 Rotary module
5 Valve unit
6 Drag chain
7 Stand
8 Electric cable
9 Stand
10 Electric motor
11 Gears
12 Angle adapter
13 Electric motor
14 Gears
15 Base part
16 Rotary part
17 Drive shaft
18 Threaded connection
19 Threaded connection
20 Threaded connection
21 Threaded connection
22 Adapter
23 Tappet
24 Rotary bushings
25 Rotary bushings
26 Rotary bushing
27 Forward line
28 Return line
29 Control cables
30 Valve
31 Valve
32 Valve
33 Valve
34 Valve
35 Fluid connection
36 Fluid connection
37 Fluid connection
38 Fluid connection
39 Fluid connection
40 Clamping device

1.-14. (canceled)

15. A rotary module for rotatably positioning a component comprising:
a) a base part having a mounting option for mounting the rotary module;
b) a rotary part with a mounting option for mounting the component on the rotary module, wherein the rotary part is rotatable relative to the base part;
c) at least one rotary bushing for passing through lines between the base part and the rotary part; and
d) wherein the at least one rotary bushing accommodates a forward line and a return line for a fluid, wherein the forward line conducts the fluid from the base part to the rotary part, while the return line conducts the fluid back from the rotary part to the base part.

16. The rotary module according to claim 15, wherein the rotary module is selectively configurable for a motorized drive or for a manual drive.

17. The rotary module according to claim 16, wherein the motorized drive works electromotively, pneumatically or hydraulically.

18. The rotary module according to claim 16, wherein:
a) the motorized drive has a rotary motor and a worm gear; and
b) the worm gear is self-locking such that the worm gear blocks a rotary motion of the rotary part relative to the base part when the rotary motor is stationary.

19. The rotary module according to claim 15, further comprising an indexing device for locking the rotary part relative to the base part in specified discrete angular positions.

20. The rotary module according to claim 15, wherein the at least one rotary bushing is supported in an elastic bearing in the rotary module.

21. The rotary module according to claim 20, wherein:
a) the at least one rotary bushing accommodates at least four fluid lines;
b) the at least one rotary bushing accommodates at least one electric cable;
c) the at least one electric cable runs centrally in the rotary bushing; and
d) the at least four fluid lines run off-center in the rotary bushing.

22. The rotary module according to claim 15, wherein:
a) the rotary module has a roller bearing for rotatably supporting the rotary part and the base part,
b) the at least one rotary bushing runs through an inner ring of the roller bearing, and
c) the roller bearing is a wire race bearing.

23. The rotary module according to claim 15, wherein:
a) the rotary part and the base part have couplings for attaching fluid lines and/or an electric cable; and
b) the couplings are plug-in couplings.

24. The rotary module according to claim 15, further comprising an angle adapter which is fixed to the base part or the rotary part and enables angled mounting.

25. The rotary module according to claim 15, wherein:
a) a valve unit is mounted on the rotary part;
b) the valve unit is connected on an inlet side to fluid lines coming from the base part and on an outlet side has a plurality of independently controllable fluid connections;
c) the valve unit is actuated by electric cables coming from the base part; and
d) a number of independently controllable fluid connections of the valve unit is greater than a number of fluid lines coming from the base part.

26. The rotary module according to claim 15, wherein at least one of the following components is mounted on the rotary part:
a) a valve;
b) a relay;
c) a clamping device which is actuated via fluid connections of the valve unit;
d) a sensor;
e) an angle adapter;
f) a valve unit; and
g) a quick-release unit.

27. A handling device having at least one rotary module according to claim 15.

28. A handling device having a plurality of rotary modules according to claim 15, wherein the rotary modules are arranged kinematically in series.

29. The handling device according to claim 28, wherein the rotary modules have differently aligned rotary axes.

30. The handling device according to claim 29, wherein a lifting column is provided for a vertical lifting movement of the rotary modules.

31. The handling device according to claim 30, wherein the lifting column has a drag chain for introducing media.

32. The handling device according to claim 28, wherein the handling device is accessible on more than five sides for mounting operations.

33. The handling device according to claim 28, further comprising:
a) a lifting column which enables a vertical lifting movement;
b) a first rotary module which is mounted on the lifting column and has a vertical rotary axis; and
c) a second rotary module which is mounted on the rotary part of the first rotary module and has a horizontal rotary axis.
